(19) United States
(12) Patent Application Publication
(10) Pub. No.: US 2024/0243839 A1
(43) Pub. Date: Jul. 18, 2024

(54) ENHANCED RETRANSMISSION FOR SIDELINK COMMUNICATIONS

(71) Applicant: Toyota Jidosha Kabushiki Kaisha, Toyota-shi, Aichi-ken (JP)

(72) Inventor: Hamidreza BAGHERI, Guildford (GB)

(73) Assignee: Toyota Jidosha Kabushiki Kaisha, Toyota-shi, Aichi-ken (JP)

(21) Appl. No.: 18/559,436

(22) PCT Filed: May 9, 2022
(86) PCT No.: PCT/US2022/028360

§ 371 Date: Nov. 7, 2023

Related U.S. Application Data
(60) Provisional application No. 63/187,282, filed on May 11, 2021.

(51) Int. Cl. H04L 1/00; H04L 1/08; H04L 1/1812; H04W 72/1268; H04W 72/231; H04W 72/25

(52) U.S. Cl. CPC H04L 1/0038; H04L 1/08; H04L 1/1812; H04W 72/1268; H04W 72/231; H04W 72/25

(57) ABSTRACT

A method of enhanced retransmission in sidelink communications includes determining, by a user equipment (UE) based on a first number of blind retransmissions in a blind retransmission mode, a plurality of resources for an initial transmission and a blind retransmission of a first transport block (TB) via a physical sidelink shared channel (PSSCH); transmitting the first TB and the first number of blind retransmissions of the first TB; and in response to not receiving a positive acknowledgement after the first number of the blind retransmissions, switching from the blind retransmission mode to a hybrid automatic repeat request (HARQ)-based retransmission mode.

### CROSS-REFERENCE TO RELATED APPLICATIONS

This application is a § 371 national phase of PCT/US2022/028360, filed May 9, 2022, which claims priority under 35 USC § 119(e) from U.S. Provisional Patent Application No. 63/187,282, filed on May 11, 2021, each of which is incorporated herein by reference.

### BACKGROUND OF THE INVENTION

The present invention is directed to 5G, which is the 5th generation mobile network. It is a new global wireless standard after 1G, 2G, 3G, and 4G networks. 5G enables networks designed to connect machines, objects and devices.

The invention is more specifically directed to enhanced retransmission in sidelink communications, for example, by determining, by a user equipment (UE) based on a first number of blind retransmissions in a blind retransmission mode, a plurality of resources for an initial transmission and a blind retransmission of a first transport block (TB) via a physical sidelink shared channel (PSSCH); transmitting the first TB and the first number of blind retransmissions of the first TB; and in response to not receiving a positive acknowledgement after the first number of the blind retransmissions, switching from the blind retransmission mode to a hybrid automatic repeat request (HARQ)-based retransmission mode.

### SUMMARY OF THE INVENTION

In an embodiment, the invention provides a method of enhanced retransmission in sidelink communications. The method includes determining, by a user equipment (UE) based on a first number of blind retransmissions in a blind retransmission mode, a plurality of resources for an initial transmission and a blind retransmission of a first transport block (TB) via a physical sidelink shared channel (PSSCH); transmitting the first TB and the first number of blind retransmissions of the first TB; and in response to not receiving a positive acknowledgement after the first number of the blind retransmissions, switching from the blind retransmission mode to a hybrid automatic repeat request (HARQ)-based retransmission mode.

The first number may indicate a maximum number of blind retransmissions. The method may further comprise receiving one or more messages comprising a first configuration parameter indicating the first number. The one or more messages preferably comprise one or more radio resource control (RRC) messages. The method may further comprise receiving a downlink control information (DCI) indicating the first number. The downlink control information (DCI) preferably comprises scheduling information for scheduling of the first transport block (TB). In the method, the downlink control information (DCI) indicates first radio resources and determining the plurality of resources is further based on the first radio resources.

Preferably, the resources of the plurality of resources are arranged in consecutive slots and frequency-domain resources of the plurality of resources are based on the first radio resources. For that matter, the method may further comprise receiving a downlink control information (DCI) comprising scheduling information for scheduling the first transport block (TB) and an indication of first radio resources, wherein determining the plurality of resources is further based on the first radio resources and the first number. In that case, the resources of the plurality of resources are in consecutive slots and frequency-domain resources of the plurality of resources are based on the first radio resources. The method may further comprise receiving a positive acknowledgement and transmitting the first transport block (TB) in the hybrid automatic repeat request (HARQ)-based retransmission mode.

In an embodiment, the invention provides a method of enhanced retransmission in sidelink communications, including receiving, by a first user equipment (UE) from a second UE, an initial transmission and one or more blind retransmission of a first transport block (TB) via a physical sidelink shared channel (PSSCH); determining, by the first UE and based on the initial transmission and the one or more blind retransmissions of the first TB, that the first TB is received correctly; and transmitting, by the first UE, an indication to release first radio resources of a plurality of resources used for the blind retransmission of the first TB that occur after correct reception of the first TB.

Transmitting the indication preferably is via a scheduling request wherein the indication is transmitted by the first UE to a base station (BS). Alternatively, the transmitting the scheduling request is via a physical uplink control channel (PUCCH). The indication may be a hybrid automatic repeat request (HARQ) feedback; the indication may be transmitted via one or more radio resource control (RRC) messages. The indication may be transmitted via a physical uplink control channel (PUCCH), or via a physical uplink shared channel (PUSCH).

In an embodiment, the invention provides a method of enhanced retransmission in sidelink communications, including receiving, by a first user equipment (UE) from a second UE, sidelink control information (SCI) comprising scheduling information for a first transport block (TB), wherein the first UE is in a groupcast set; receiving, by the first UE from the second UE, the first TB; and transmitting, by the first UE, a first negative acknowledgement where the first TB is received incorrectly by the first UE. Preferably, the receiving includes receiving one or more repetitions of the first transport block (TB), and the transmitting includes transmitting second or more negative acknowledgments, where the first TB is received incorrectly until the first TB is received correctly through the one or more repetitions, and wherein the one or more repetitions of the first TB are based on blind retransmissions by the second user equipment (UE).

Preferably, the first user equipment (UE) does not transmit a negative acknowledgement when the first transport block (TB) is received correctly. Receiving the sidelink control information (SCI) may be via a physical sidelink control channel (PSCCH); receiving the one or more repetitions of the first TB may be via a physical sidelink shared channel (PSSCH). Transmitting the second or more negative acknowledgements is via a physical sidelink feedback channel (PSFCH). Preferably, the groupcast set comprises a plurality of user equipments (UEs) comprising the first UE and the first transport block (TB) is received by the plurality of UEs. The plurality of user equipments (UEs), in the groupcast set, share physical sidelink feedback channel (PSFCH) resources for transmission of the second or more negative acknowledgements. For that matter, transmitting the first negative acknowledgement is further based on one or more criteria, and each criterion in the one or more criteria is based on a parameter.

The method may further include receiving one or more messages comprising the parameter. Preferably, the one or more messages comprises a radio resource control (RRC) message, and a criterion in the one or more criteria is based on a zone that the first user equipment (UE) is located in. The first user equipment (UE) is associated with a first zone identifier and the second UE is associated with a second zone identifier. For that matter, the sidelink control information (SCI) comprises parameters indicating at least one of the first zone identifier and the second zone identifier. And a criterion in the one or more criteria preferably is based on a distance between the first user equipment (UE) and the second UE. Transmitting the first negative acknowledgement is further based on the distance being larger than a threshold, and a criterion of the one or more criteria is based on a received signal received power (RSRP) measured at the first user equipment (UE).

Preferably, transmitting the first negative acknowledgement is further based on the received signal received power (RSRP) being smaller than a threshold. For that matter, the sidelink control information (SCI) may comprise a field with a value indicating whether negative acknowledgement only feedback is enabled or disabled, or alternatively, may comprise a field with a value indicating one of a plurality of feedback modes.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16 shows example multiplexing mechanisms for physical sidelink shared channel (PSSCH)/physical sidelink control channel (PSCCH) and physical sidelink feedback channel (PSFCH) according to some aspects of some of various exemplary embodiments of the present disclosure.

FIG. 17 shows an example process according to some aspects of some of various exemplary embodiments of the present disclosure.

FIG. 18 shows an example process according to some aspects of some of various exemplary embodiments of the present disclosure.

FIG. 19 shows an example process according to some aspects of some of various exemplary embodiments of the present disclosure.

### DETAILED DESCRIPTION

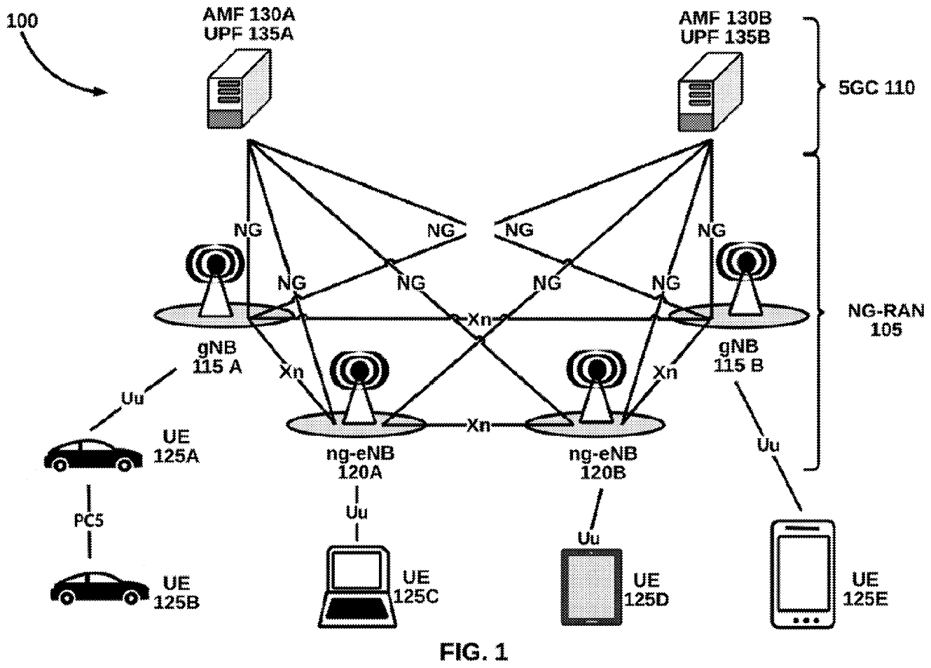

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Example of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIOT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that originates sidelink communication frames. The Destination Layer-2 ID may be a link-layer identity that identifies a device that are recipients of sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

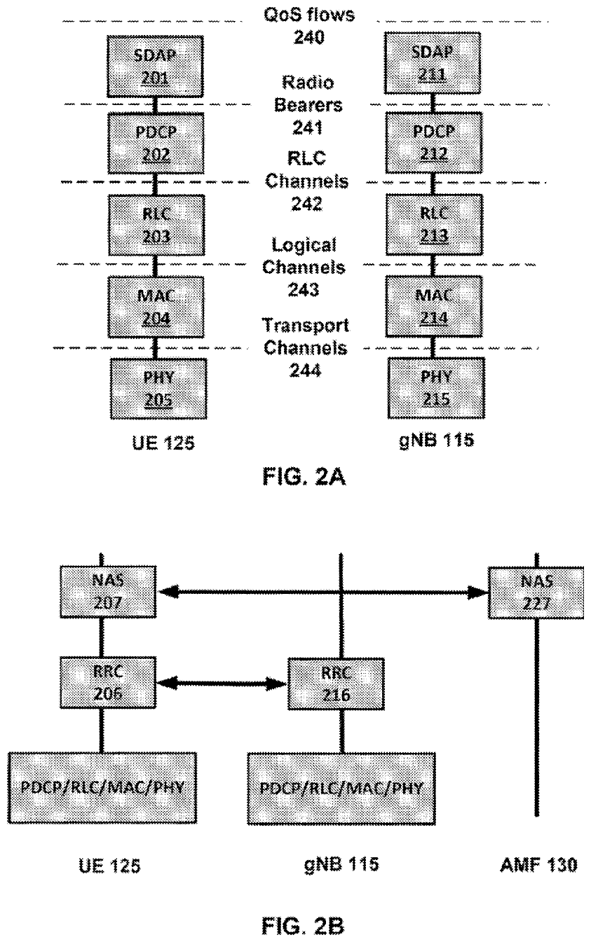

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or more different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

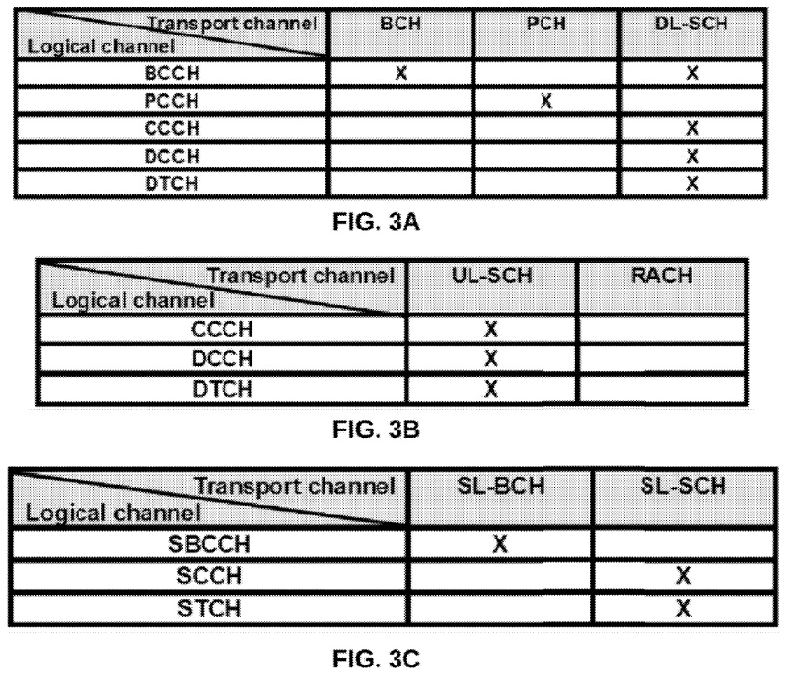

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

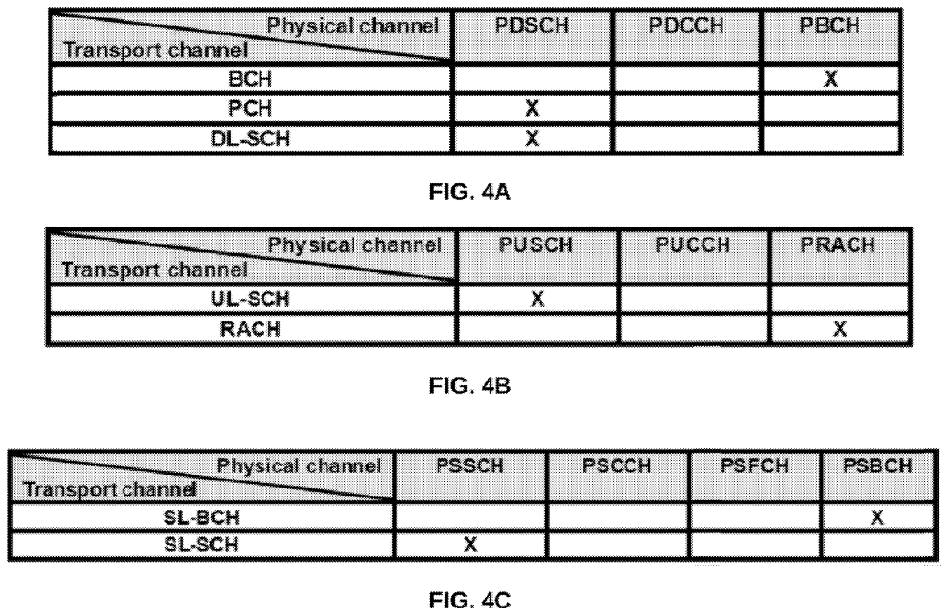

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

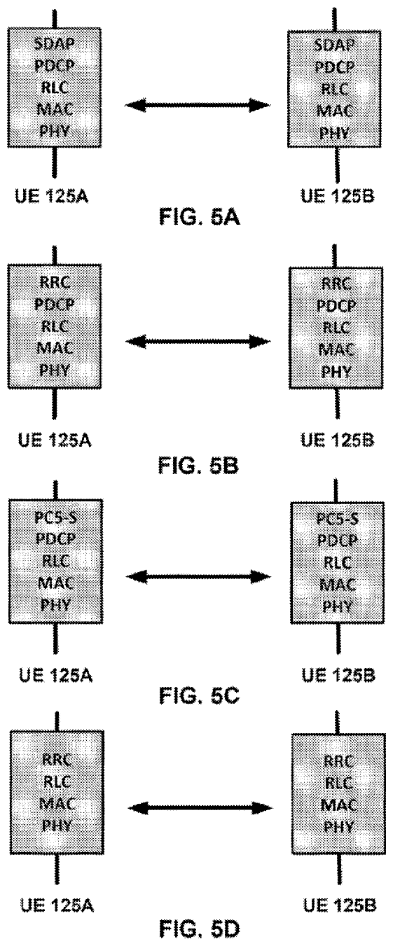

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

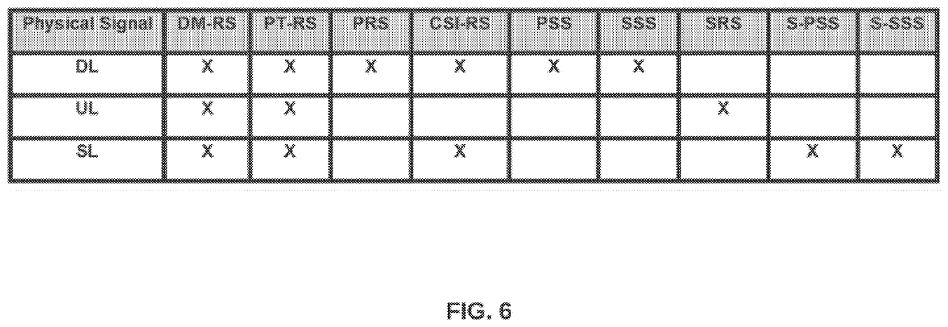

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

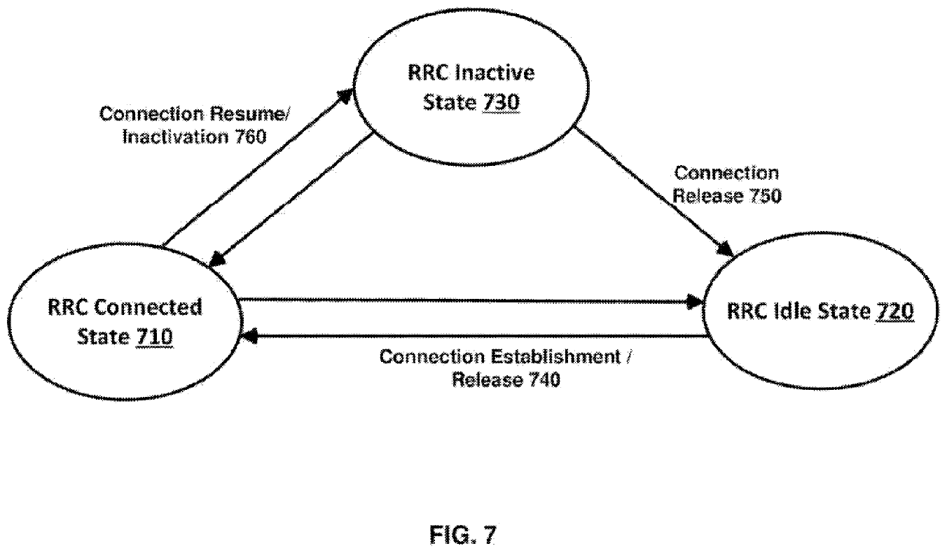

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

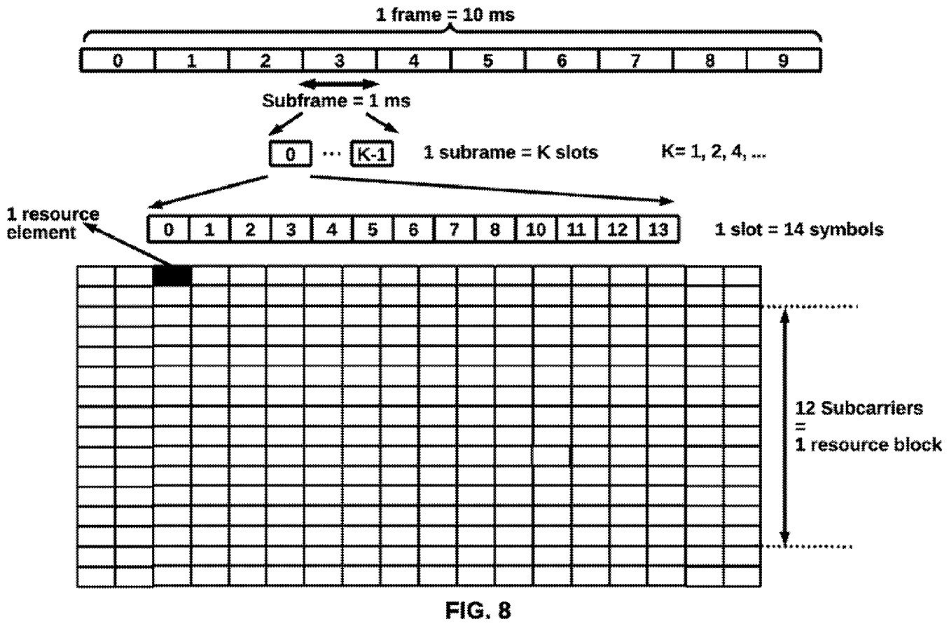

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend of the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

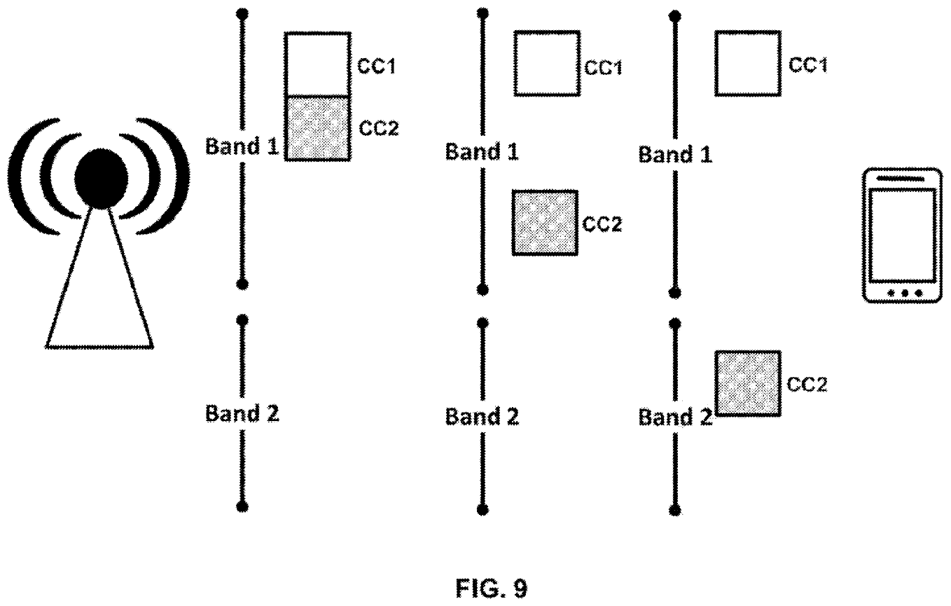

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary Cell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity for the MCG for communications with the master base station and one MAC entity for the SCG for communications with the secondary base station.

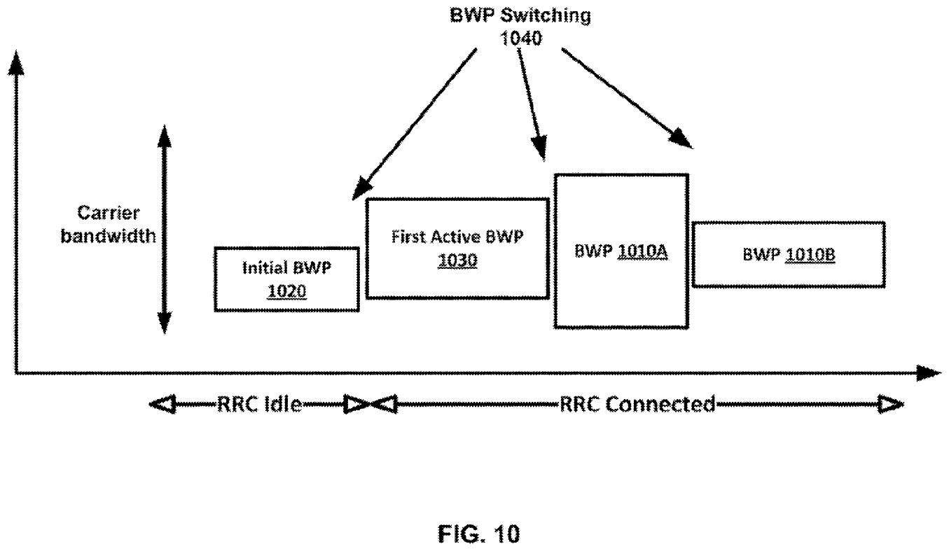

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g., to shrink during period of low activity to save power); the location may move in the frequency domain (e.g. to increase scheduling flexibility); and the subcarrier spacing may be ordered to change (e.g. to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

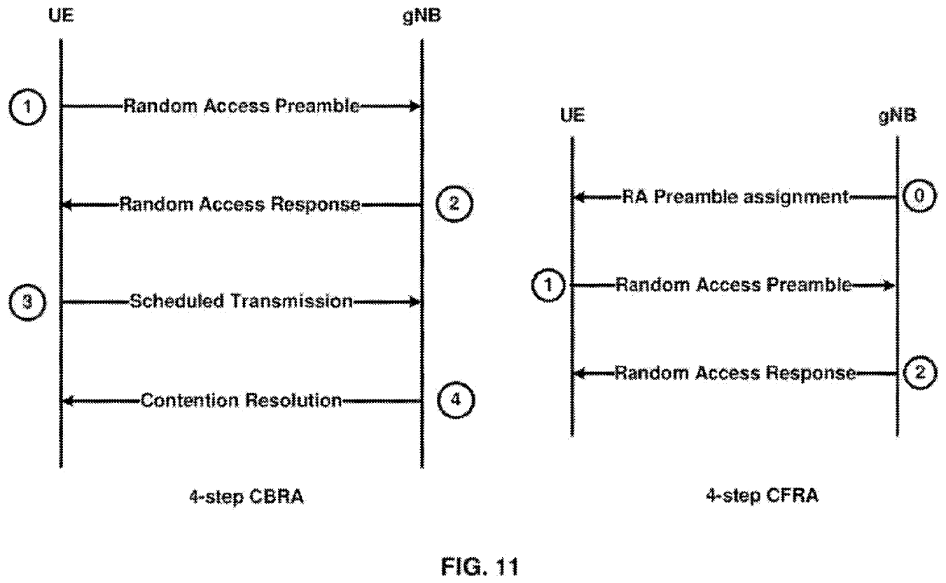

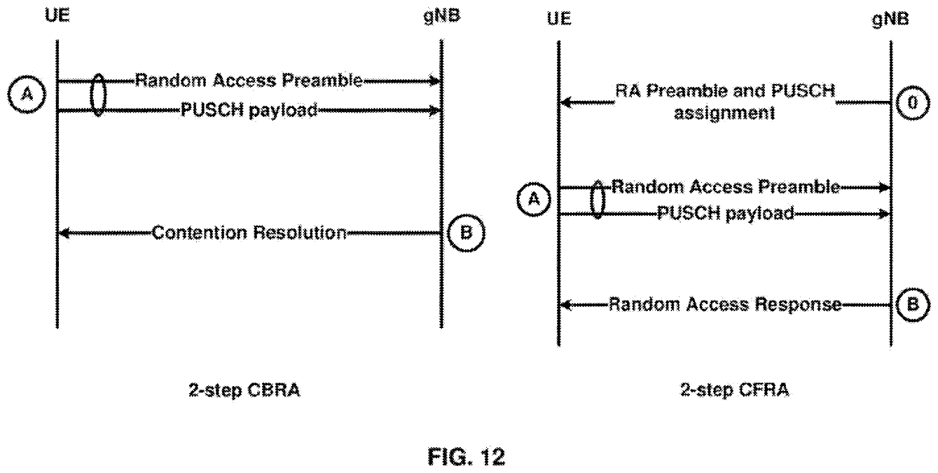

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

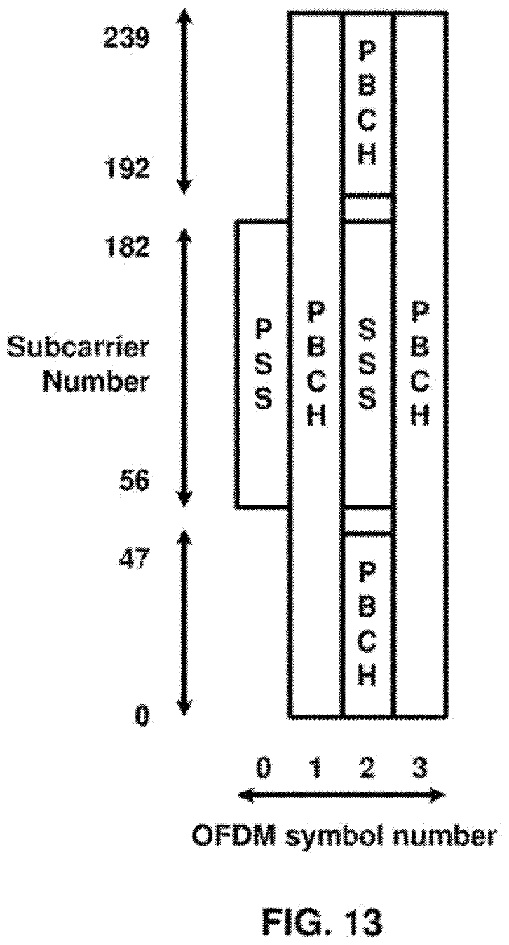

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e., using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

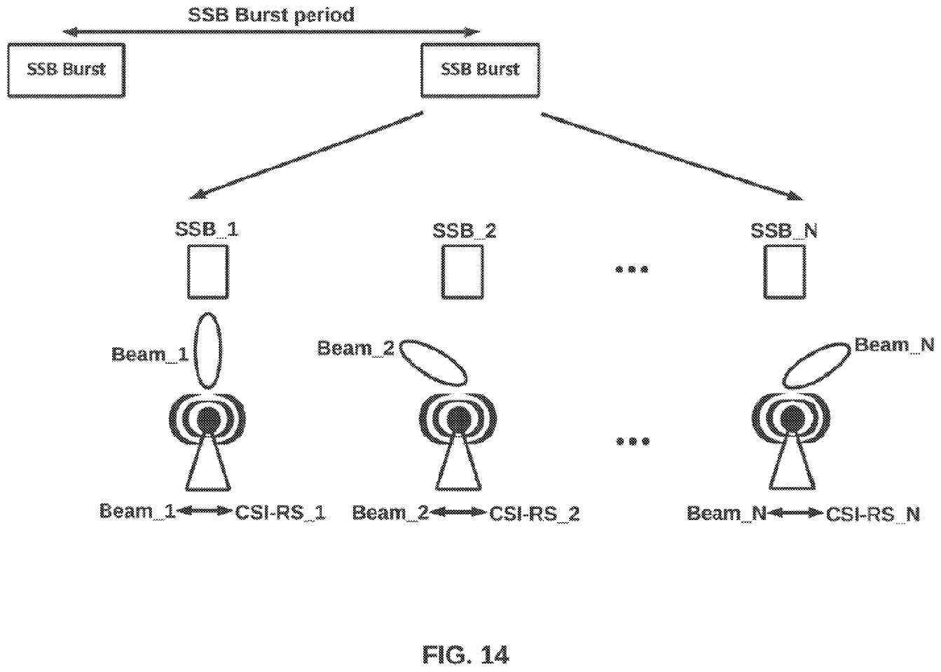

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depends on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

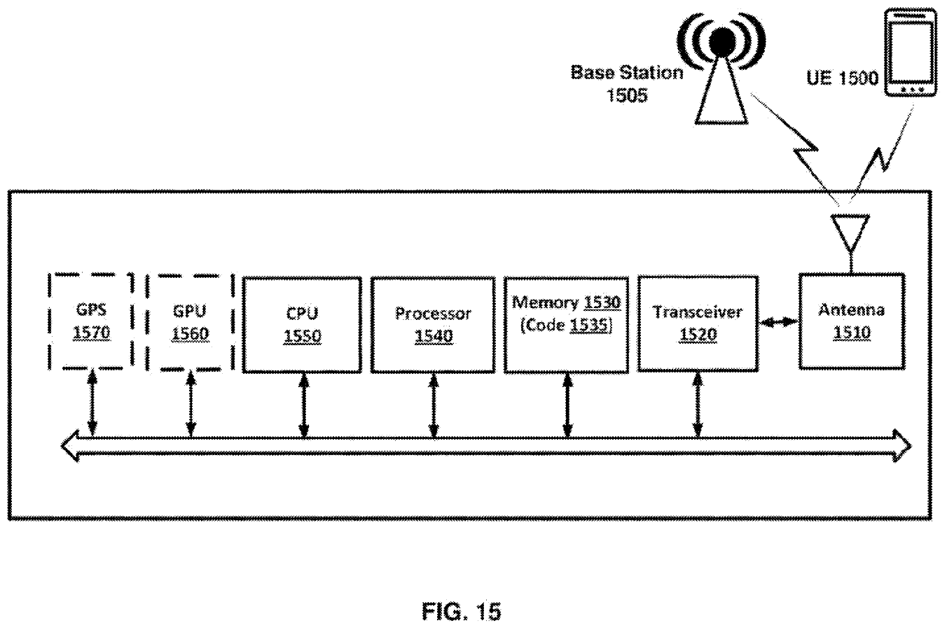

FIG. 15 shows example components of a user equipment and a base station for transmission and/or reception according to some aspects of some of various exemplary embodiments of the present disclosure. All or a subset of blocks and functions in FIG. 15 may be in the base station 1505 and the user equipment 1500 and may be performed by the user equipment 1500 and by the base station 1505. The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples and depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In some examples, a plurality of sidelink resource allocation modes may be used for sidelink communications. The plurality of resource allocation modes may comprise mode 1 resource allocation and mode 2 resource allocation. In mode 1, the sidelink resource allocation may be provided by the network (e.g., the base station). In mode 2, a UE may decide the sidelink transmission resources in the one or more resource pools. The UE may receive configuration parameters (e.g., RRC configuration parameters) of the one or more resource pools. The resource pool configuration parameters may indicate time and frequency resources of the one or more resource pools.

In some examples, in sidelink resource allocation mode 1, a UE may receive sidelink HARQ feedback via physical sidelink feedback channel (PSFCH). The UE that receives the sidelink HARQ feedback via PSFCH may report the sidelink HARQ feedback to a gNB via PUCCH or PUSCH.

In some examples, for NR sidelink communication, the UE may operate in a plurality of modes for resource allocation in sidelink. The plurality of modes may comprise scheduled resource allocation and UE autonomous resource allocation. The scheduled resource allocation may be characterized by the following: the UE may need to be RRC_CONNECTED in order to transmit data; and NG-RAN (e.g., base station) may schedule transmission resources. The UE autonomous resource selection may be characterized by: the UE may transmit data when inside NG-RAN coverage, irrespective of which RRC state the UE is in, and when outside NG-RAN coverage; the UE may autonomously select transmission resources from one or more resource pools.

In some examples, NG-RAN (e.g., base station) may dynamically allocate resources to the UE via a SL-RNTI on one or more PDCCHs for NR sidelink communication. In addition, NG-RAN may allocate sidelink resources to a UE with two types of configured sidelink grants: With type 1, RRC may directly provide the configured sidelink grant only for NR sidelink communication; With type 2, RRC may define the periodicity of the configured sidelink grant while PDCCH may either signal and activate the configured sidelink grant or may deactivate it. The PDCCH may be addressed to SL-CS-RNTI for NR sidelink communication.

In some examples, NG-RAN may semi-persistently allocate sidelink resources to the UE via the SL Semi-Persistent Scheduling V-RNTI on one or more PDCCHs for V2X sidelink communication.

In some examples, the UE may autonomously select sidelink resource(s) from resource pool(s) provided by broadcast system information or dedicated signaling while inside NG-RAN coverage or by pre-configuration while outside NG-RAN coverage.

In some examples, for NR sidelink communication, the resource pool(s) may be provided for a given validity area where the UE may not need to acquire a new pool of resources while moving within the validity area, at least when this pool is provided by SIB. The NR SIB area scope mechanism may be reused to enable validity area for SL resource pool configured via broadcasted system information.

In some examples, the UE may be allowed to temporarily use UE autonomous resource selection with random selection for sidelink transmission based on configuration of an exceptional transmission resource pool.

In some examples, an IE SL-BWP-Config may be used to configure the UE specific NR sidelink communication on one particular sidelink bandwidth part. In some examples, an IE SL-BWP-ConfigCommon may be used to configure the cell-specific configuration information on one particular sidelink bandwidth part. In some examples, an IE SL-BWP-PoolConfig may be used to configure NR sidelink communication resource pool. In some examples, an IE SL-BWP-PoolConfigCommon may be used to configure the cell-specific NR sidelink communication resource pool.

In some examples, resource allocation mode 2 may include resource exclusion and resource selection from candidate resources. For mode 2 sidelink, resource exclusion may be based on the transmitter's sensing results. After resource selection, the transmitter may indicate reserved resources in the PSCCH. The reserved resources may be used for transmission and retransmission. To guarantee the reliability, one TB transmission may reserve several resources for retransmission. If other transmitter receives the transmission and decodes the reservation information in PSCCH, it may exclude these reserved resources when resource selection.

In some examples, the reservation-based transmission may reserve several resources for initial transmission and retransmission. In some examples, a reservation may reserve the resources used for initial transmission and other retransmission resources. The retransmission may be either blind or HARQ-based retransmission.

In some examples, there may be two types of retransmissions, blind retransmission and HARQ-based retransmission. The blind retransmission may reserve several resources to transmit duplicate packets. To ensure reliability without the feedback information, the transmitter may fully use the reserved resources. Hence the reserved resources for blind retransmission may have no chance to be reused by other transmitters. For the HARQ-based retransmission, one TB may reserve several resources for retransmission. When the transmitter receives the NACK, it may utilize reserved resources to perform retransmissions until the reception of ACK or without the NACK reception in corresponding feedback resources. When the transmitter receives the ACK or receives no NACK in the feedback channel, it may consider it a successful transmission.

In some examples, a physical sidelink feedback channel (PSFCH) may be used to transmit HARQ ACK feedback for Sidelink transmissions. In some examples, a wireless device may determine allocation time/frequency resource for PSFCH transmission and multiplexing relationship between PSFCH and PSCCH/PSSCH.

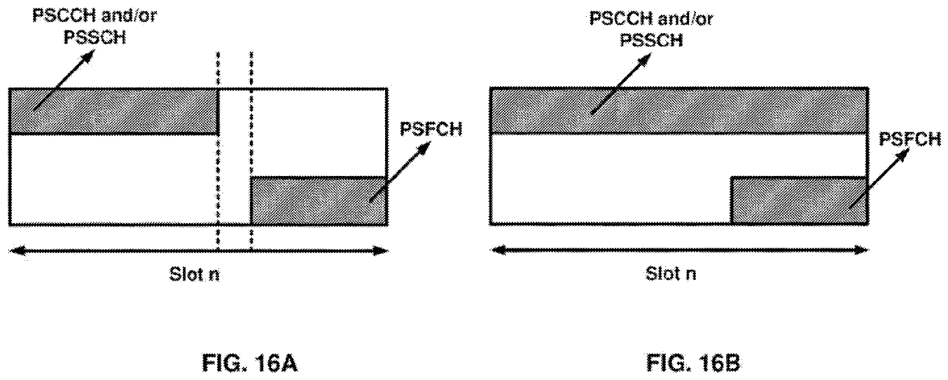

In some examples, for multiplexing PSCCH/PSSCH and PSFCH in a slot, the PSCCH/PSSCH may be non-overlapped with PSFCH in the time domain in a slot, as illustrated in FIG. 16A.

In some examples, the PSCCH/PSSCH may be overlapped with PSFCH in the time domain in a slot, as illustrated in FIG. 16B.

In some examples, resource allocation modes 1 and mode 2 for NR Sidelink transmission may be configured separately or simultaneously. In Mode 1, Sidelink resources may be scheduled by a gNB. In Mode 2, the UE may autonomously sense and select Sidelink resources from a pre-configured Sidelink resource pool(s), based on network configuration. The resource allocation mode may be dependent on network topology and in-coverage and out-of-coverage scenario. For in-coverage UE, a gNB may adopt Mode1 or Mode2. For out-of-coverage UE, Mode2 of resource allocation may be adopted.

In some examples, NR Sidelink may support unicast, groupcast and broadcast transmission. In some examples, for unicast and groupcast, PSFCH may be used for a receiving UE to reply decoding status to a transmitting UE. PSFCH may be configured to operate in a plurality of scenarios. In some example scenarios, which may be configured for both unicast and groupcast, PSFCH may transmit either ACK or NACK using a resource dedicated to a single PSFCH transmitting UE. In another scenario, which may be configured for groupcast, PSFCH may transmit NACK, or no PSFCH signal may be transmitted, on a resource that may be shared by multiple PSFCH transmitting UEs.

In some examples for resource allocation for PSFCH transmission, fixed or preconfigured time/frequency relationship between PSSCH and the associated PSFCH may be used. The resource determination procedure of SL HARQ feedback may be simplified and to reduce the overhead of TX/RX turnaround time, feedback resources may appear periodically as per the configuration. If the time/frequency location of PSFCH is correlated with the corresponding PSSCH, it may be beneficial to avoid the resource collision in SL HARQ feedback transmission.

In some examples for resource allocation for PSFCH transmission, flexible time/frequency relationship between PSSCH and the associated PSFCH may be used. This approach may be used in multiple types of services with different latency requirements and UE capabilities.

In some examples, the transmitter UE may determine the SL HARQ feedback resource. The SL HARQ feedback resource may be avoided by others when there is sufficient processing time, once the SCI scheduling PSSCH is detected by the surrounding UEs. The transmitter may not need to blindly detect the SL HARQ feedback.

In some examples, a receiver UE may determine the SL HARQ feedback resource. The SL HARQ feedback resource may be selected taking into account current operation at the receiver UE, for example its own schedule to transmit PSSCH and PSCCH, sensing information, etc.

The blind retransmission may reduce the latency by not waiting for HARQ feedback, while the feedback-based approach increases the reliability. In blind re-transmission, there may be no feedback on transmitter which may be waste of spectrum and may increase the system overhead. The feedback-based re-transmission, however, may provide efficient spectrum usage but latency becomes the main problem with it. Example embodiments may utilize a mixed mechanism of blind and feedback-based approaches for HARQ re-transmissions of a TB. Example embodiments may reduce the number of blind retransmissions and may enable dynamic management of reserved resources (e.g., by releasing the reserved resources).

In some examples, for the case of unicast, a maximum number of blind re-transmissions, m, may be defined and then a feedback-based approach may be followed. In some examples, m=2.

In some examples, when the receiving UE successfully decodes the PSCCH and related TB, the receiving UE may generate a HARQ-ACK and may transmit to the transmitting UE. With this policy, transmitting UE may inform its associated BS to release the reserved resources. This may be done by PHY layer signaling via PUCCH or PUSCH or it may be implemented using RRC.

In some examples in case of groupcasting, feedback for sidelink transmissions may be disabled.

In some examples in case of groupcasting, if the receiving UE successfully decodes the PSCCH but fails to decode the related TB, the receiving UE may generate a HARQ-NACK and may transmit to the transmitting UE through PSFCH. This may continue until when the transmitting UE does not receive a HARQ-NACK. In some examples, UEs in this groupcast may share PSFCH resources. In some examples, the UEs which successfully decoded the TB may not transmit HARQ-ACK to the transmitting terminal.

In some examples, to further improve the SL HARQ feedback in groupcast scenarios, a parameter may determine whether to send the SL HARQ feedback. For example, a zone-based or distance-based (distance between Tx-Rx) criteria with an optional RSRP may be used for this purpose. If the instantaneous distance between Tx and Rx in groupcast is greater than to the SL communication range, the receiving UE may transmit HARQ-NACK to the transmitting UE. If Tx-Rx distance is less than or equal to the SL communication range, the receiving UE may not transmit HARQ feedback to the transmitting UE. These approaches may be presented in a Zone-based approach. A TX and RX may be identified with a Zone-ID.

In some examples, a plurality of SCI formats may be used. In some examples, a SCI format with TX-RX distance or/and Zone-ID may be used. In this case, one additional bit may be needed to be used to indicate whether groupcast HARQ feedback is enabled or disabled. In some examples, the SCI format without any TX-RX distance or Zone-ID may be used. In this case, SCI format may need two additional bits to be used to indicate no HARQ (00), groupcast with TX-RX distance and/or Zone-ID (01), groupcast without TX-RX distance and/or Zone-ID (10), and broadcast (11).

In some examples in case of groupcasting, if the receiving UE successfully decodes the PSCCH and related TB, the receiving UEs does not need to send HARQ-ACK to the transmitting UE.

In some examples, there may two resource allocation modes for NR SL communications, namely mode 1 and mode 2.

In some examples, for resource allocation mode 1, in both unicast and groupcast, if retransmission is needed on the SL, the UE may request this to the associated BS using scheduling request (SR) over PUCCH.

In some examples, for resource allocation mode 2, a time domain strategy may be used to multiplex PSCCH/PSSCH and PSFCH. In some examples, in a sequence-based PSFCH HARQ feedback, different PSFCHs corresponding to the different PSCCH/PSSCHs may be transmitted in non-overlapping reserved resources. This strategy many increase the latency and may limit the resource efficiency. An example solution may be to exploit a frequency domain and/or a code domain for multiplexing PSCCH/PSSCH and PSFCH. Another example solution may be to develop a dynamic and flexible PSFCH resource allocation with a defined priority. For example, a UE may select a specific SL HARQ feedback transmission based on a pre-defined priority policy. As an example of priority policy in unicast scenarios, the priority may be given to PSFCH, while in groupcast scenarios PSSCH and PSFCH may have the equal priority but a signal indicator may determine the priority based on Tx-Rx distance.

For the existing resource allocation or resource management solutions for PSFCH transmission, the network resource utilization may be limited, for example, in cases of large number of blind retransmission and large PSFCH resource reservation. There is a need enhance mechanisms for PSFCH resources allocation.

In some examples, sidelink transmissions may support both unicast and groupcast. An efficient solution may address resource allocation for PSFCH on both unicast and multicast transmission modes. The transmitting and receiving UEs of a Sidelink transmission may operate on Mode 1 or Mode 2 of resource allocation. The PSFCH resource allocation mechanism may consider a method to address resource efficiency on these modes as well.

In some examples, resource allocation for PSFCH for a UE may be configured (or pre-configured) by a serving base station or by the UE. The information regarding the PSFCH resources configured by the UE may be exchanged between UEs through a predefined signalling which may be L1, L2, or RRC signalling. The PSFCH resource allocation may comprise an implicit mapping rule between PSCCH/PSSCH and PSFCH.

Example embodiments may enhance resource efficiency for HARQ Sidelink retransmissions. A large number of blind retransmission may be reduced and/or the reserved resource may be dynamically managed to be released whenever no further retransmission is needed.

Example embodiments for the unicast transmission may comprise two strategies for resource efficiency. The first strategy may be to restrict the maximum number of blind retransmissions following with a feedback-based retransmission approach to meet the required ultra-high reliability. The second strategy may be to exploit a feedback approach to release the reserved resources, either by transmitting or receiving UE.

Example embodiments for the groupcast transmission may be categorized into three strategies. The first strategy may be to disable feedback-based retransmission and just use of some restricted number of blind retransmission approach. This strategy may be beneficial in case of large group of groupcasting, as a large number of overhead transmissions may be eliminated. The second strategy for groupcasting may be to exploit the HARQ-NACK signalling with a key parameter to restrict the large number of retransmissions. This approach may be beneficial as not only all UEs in a groupcast may share PSFCH resources. The third strategy may be to prevent of transmission of HARQ-ACK signalling from receiving UEs to transmitting UE, in case of successful decoding of the PSCCH and related TB.

Example embodiments may enable efficient mapping solution between PSCCH/PSSCH and PSFCH. The time slot that PSFCH may be transmitted may be determined by a specific time point (e.g., specific slot number) and/or a time slot period (e.g., slot #N to slot #N+K). The existing solution, based on time domain, may increase the latency and limit the resource efficiency. Example embodiments may exploit a frequency domain and/or a code domain in addition to time domain for multiplexing PSCCH/PSSCH and PSFCH. In Mode 1, as the base station may be responsible for resource allocation, it may associate multiple PSCCH/PSSCH slots in a different time and frequency with a single PSFCH slot for a Sidelink transmission on scheduling assignments (over SCI) for both unicast and groupcast transmission.

In some examples, for groupcasting, a priority mechanism may be associated with multiple slots strategy to meet the latency requirement. In Mode 2, as the base station may not be involved, information on the PSFCH resources (e.g., frequency and/or code domain) may be indicated by SCI. With respect to frequency and code resource, the UE may set the frequency or code resource of the PSFCH based on mapping plan between the PSCCH/PSSCH and the PSFCH. For example, the receiving terminal may determine the frequency domain and/or the code domain of the PSFCH resource based on at least one of Sidelink RSRP, SINR, L1 source ID, and/or location information. A priority policy mechanism in this mode may improve the resource efficiency. For example, in case of overlap between transmission and reception of HARQ feedback, a priority policy may determine the UE behavior for resource efficiency.

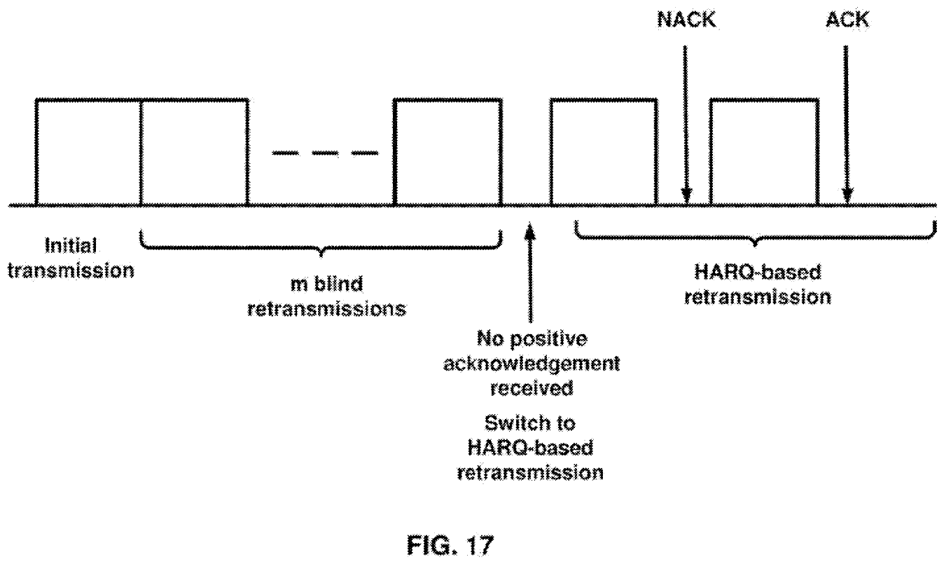

In an example embodiment as shown in FIG. 17, a UE may use a method of retransmissions in sidelink communications that is a mixture of blind retransmissions and HARQ based (e.g., based on HARQ feedback) retransmissions. The UE may start from the blind retransmission mode and may switch to the HARQ based retransmission mode. The UE may determine a plurality of resources for an initial transmission and one or more blind retransmissions of a sidelink transport block (TB). The number of the one or more blind retransmissions may be a first number (e.g., m). In an example, the first number may indicate a maximum number of blind retransmissions. In an example, the UE may receive a configuration parameter (e.g., an RRC configuration parameter) indicating the first number. In an example, a downlink control information (DCI) or a sidelink control information (SCI) (e.g., control information indicating scheduling of the TB and/or its retransmissions) may indicate the first number. In an example, the DCI or the SCI may comprise/indicate first radio resources (e.g., time-frequency domain resources) and determining the plurality of resources (for the initial transmission and the one or more blind retransmissions) may be based on the first resources and the first number. In an example, the plurality of resources (for the initial transmission and the one or more blind retransmissions) may be in consecutive slots. The UE may determine frequency domain resources of the plurality of resources based on the first resources indicated by the DCI or the SCI.

The UE may transmit the initial transmission and the one or more blind retransmissions of the sidelink TB in sidelink. The transmission of the initial transmission and the one or more blind retransmissions of the sidelink TB may be via a physical sidelink shared channel (PSSCH). The UE may determine that the initial transmission and the one or more blind retransmissions of the sidelink TB were not received successfully. For example, the UE may not receive a positive acknowledgement in response to the initial transmission and the one or more blind retransmissions of the sidelink TB and may determine that the initial transmission and the one or more blind retransmissions of the sidelink TB were not received successfully. In response to this determination, the UE may switch from the blind retransmission mode to the HARQ based retransmission mode. After switching from the blind retransmission mode to the HARQ based retransmission mode, the UE may retransmit the sidelink TB for one or more time and may receive HARQ feedback (e.g., NACK or ACK). The UE may receive an ACK indicating successful reception of the TB.

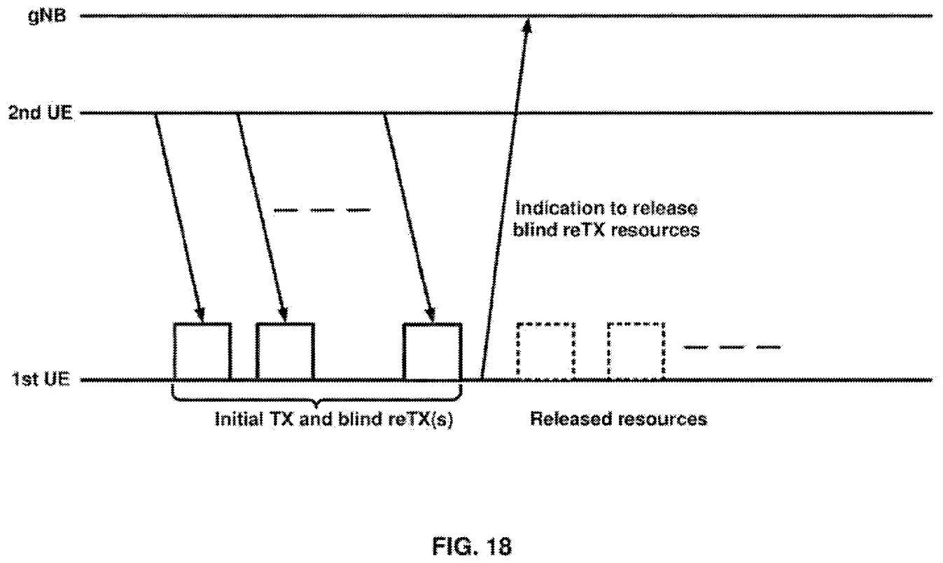

In an example embodiment as shown in FIG. 18, a UE may use an enhanced retransmission method in sidelink communications. A first UE may receive, from a second UE, an initial transmission and one or more blind retransmissions of a sidelink transport block (TB) via a physical sidelink shared channel. The first UE may determine that one of the initial transmission and the one or more blind transmission of the sidelink TB. The first UE may successfully decode the initial transmission and the one or more blind retransmissions of the sidelink TB. In response to the determination that the sidelink TB is successfully decoded based on reception of the initial transmission and the one or more blind retransmissions, the first UE may transmit an indication (e.g., to a base station) indicating release of first radio resources of a plurality of radio resources used for blind retransmission of the sidelink TB that occur after correct reception of the sidelink TB. In an example, the indication may be transmitted via a scheduling request. For example, a scheduling request configuration may be configured for the first UE which may be used for transmission of the indication. In an example, the indication may be a HARQ feedback. In an example, the indication may be a radio resource control (RRC) message. A field of an RRC message may comprise the indication. In an example, the first UE may transmit the indication (e.g., the scheduling request or the HARQ feedback) to the base station via a physical uplink control channel (PUCCH). In an example, the first UE may transmit the indication to the base station via a physical uplink shared channel (PUSCH).

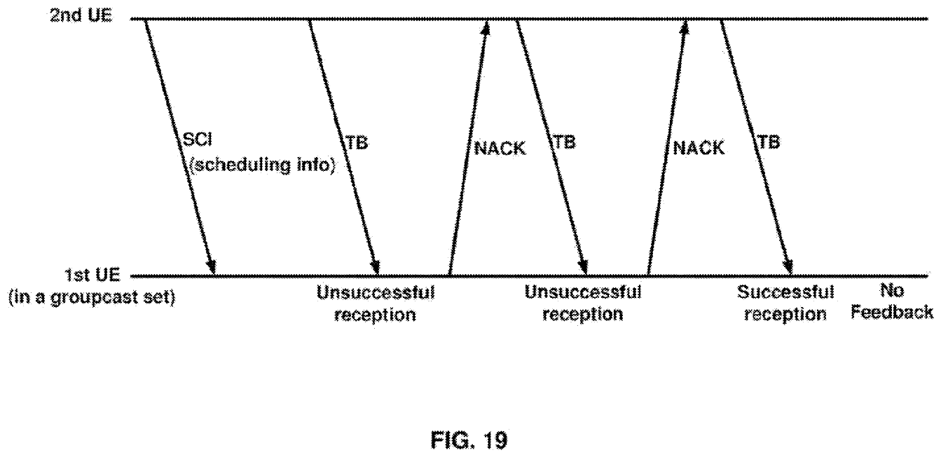

In an example embodiment as shown in FIG. 19, a UE may use an enhanced retransmission method in sidelink communications. A first UE may receive, from a second UE, sidelink control information (SCI) comprising scheduling information for a sidelink TB. The reception of the SCI may be via a physical sidelink control channel (PSCCH). The first UE may be in a groupcast set, wherein the groupcast set may comprise a plurality of UEs comprising the first UE. In an example, the groupcast set of UEs may share physical sidelink feedback channel resources for transmission of sidelink feedback. The first UE may receive one or more repetitions of the sidelink TB. In an example, the UEs in the groupcast may receive the one or more repetitions of the sidelink TB. In an example, the one or more repetitions of the sidelink TB may be based on blind retransmission of the sidelink TB. In an example, the first UE may receive the one or more repetitions of the sidelink TB via a physical sidelink shared channel.

For each repetition of the sidelink TB, the first UE may transmit a negative acknowledgement (NACK) if the sidelink TB is not received/decoded correctly until the sidelink TB is received/decoded correctly. The transmission of the negative acknowledgement may be via a physical sidelink feedback channel (PSFCH).

In an example, for each repetition of the sidelink TB that is not received/decoded correctly, the transmission of the negative acknowledgement may further be based on one or more criteria. In an example, a criterion in the one or more criteria may be based on a parameter. In an example, the first UE may receive one or more messages (e.g., one or more RRC messages) comprising the parameter. In an example, a criterion in the one or more criteria may be based on a zone that the first UE is located in. For example, the first UE may be located in a first zone associated with a first zone identifier and the second UE may be located in a second zone associated with a second zone identifier. In an example, a criterion in one or more criteria may be based on a distance between the first UE and the second UE. For example, transmitting the negative acknowledgement may be based on a distance between the first UE and the second UE being larger than a threshold (e.g., an RRC configurable threshold). In an example, a criterion in the one or more criteria, may be based on a received signal received power (RSRP) measured at the first UE. For example, transmitting a negative acknowledgement, in the one or more negative acknowledgements, may be based on a measured RSRP being smaller than a threshold (e.g., an RRC configurable threshold).

In an example, a value of a field of a SCI (e.g., a SCI scheduling the sidelink TB and/or the one or more repetitions of the sidelink TB) may indicate whether negative-only acknowledgement is enabled or disabled. In an example, a value of a field of the SCI (e.g., a SCI scheduling the sidelink TB and/or the one or more repetitions of the sidelink TB) may indicate one of a plurality of feedback modes.

For the repetition of the sidelink TB which is received/decoded correctly, the first UE may not transmit a feedback/acknowledgement.

In an embodiment, a user equipment (UE) may determine, based on a first number of one or more blind retransmissions in a blind retransmission mode, a plurality of resources for an initial transmission and blind retransmission of a first transport block (TB) via a physical sidelink shared channel (PSSCH). The UE may transmit the first TB and the one or more blind retransmissions of the first TB. In response to not receiving a positive acknowledgement after the first number of the blind retransmissions, the UE may switch from the blind retransmission mode to a hybrid automatic repeat request (HARQ)-based retransmission mode.

In some embodiments, the first number may indicate a maximum number of blind retransmissions.

In some embodiments, the UE may receive one or more messages comprising configuration parameters comprising a first configuration parameter indicating the first number.

In some embodiments, the one or more messages may comprise one or more radio resource control (RRC) messages.

In some embodiments, the UE may receive a downlink control information (DCI) indicating the first number. In some embodiments, the downlink control information (DCI) may comprise scheduling information for scheduling of the first transport block (TB). In some embodiments, the downlink control information (DCI) may indicate first radio resources. The UE may determine the plurality of resources based on the first radio resources and the first number. In some embodiments, the plurality of resources may be in consecutive slots. Frequency-domain resources of the plurality of resources may be based on the first radio resources.

In some embodiments, the UE may receive a downlink control information (DCI) comprising scheduling information for scheduling of the first transport block (TB), wherein determining the plurality of resources may be based on the first radio resources and the first number. In some embodiments, the plurality of resources may be in consecutive slots. Frequency-domain resources of the plurality of resources may be based on the first radio resources.

In some embodiments, the UE may transmit the first transport block (TB) in the HARQ-based retransmission mode. The UE may receive a positive acknowledgement.

In an embodiment, a first user equipment (UE) may receive from a second UE, an initial transmission and one or more blind retransmission of a first transport block (TB) via a physical sidelink shared channel (PSSCH). The first UE may determine that one of the initial transmission and the one or more blind retransmissions of the first transport block is received correctly. The first UE may transmit an indication to release first radio resources of a plurality of resources used for the blind retransmission of the first TB that occur after correct reception of the first TB.

In some embodiments, the first UE may transmit the indication via a scheduling request. In some embodiments, the indication may be transmitted by the first UE to a base station (BS). In some embodiments, the first UE may transmit the scheduling request via a physical uplink control channel.

In some embodiments, the indication may be a hybrid automatic repeat request (HARQ) feedback.

In some embodiments, the first UE may transmit the indication via one or more radio resource control (RRC) messages.

In some embodiments, the first UE may transmit the indication via a physical uplink control channel (PUCCH).

In some embodiments, the first UE may transmit the indication via a physical uplink shared channel (PUSCH).

In an embodiment, a first user equipment (UE) may receive from a second UE, sidelink control information (SCI) comprising scheduling information for a first transport block (TB), wherein the first UE is in a in a groupcast set. The first UE may receive from the second UE, one or more repetitions of the first TB. The first UE may transmit one or more negative acknowledgements until the first TB is received correctly by the first UE.

In some embodiments, the second UE may receive the one or more repetitions of the first transport block (TB) based on blind retransmissions.

In some embodiments, the first user equipment (UE) may not transmit an acknowledgement when the first TB is received correctly.

In some embodiments, the first UE may receive the sidelink control information (SCI) via a physical sidelink control channel (PSCCH).

In some embodiments, the first UE may receive the one or more repetitions of the first TB via a physical sidelink shared channel (PSSCH).

In some embodiments, the first UE may transmit the one or more negative acknowledgements via a physical sidelink feedback channel (PSFCH).

In some embodiments, the groupcast set may comprise a plurality of user equipments (UEs) comprising the first UE. The first transport block (TB) may be received by the plurality of UEs.

In some embodiments, the plurality of UEs, in the groupcast set, may share physical sidelink feedback channel (PSFCH) resources for transmission of negative acknowledgements.

In some embodiments, transmitting a first negative acknowledgement in the one or more negative acknowledgements may further be based on one or more criteria. In some embodiments, a criterion in the one or more criteria may be based on a parameter. In some embodiments, the first UE may receive one or more messages comprising the parameter. In some embodiments, the one or more messages may comprise a radio resource control (RRC) message. In some embodiments, a criterion in the one or more criteria may be based on a zone that the first user equipment (UE) is located in. In some embodiments, the first user equipment (UE) may be associated with a first zone identifier and the second UE may be associated with a second zone identifier. In some embodiments, the sidelink control information (SCI) may comprise parameters indicating at least one of the first zone identifier and the second zone identifier. In some embodiments, a criterion in the one or more criteria may be based on a distance between the first user equipment (UE) and the second UE. In some embodiments, transmitting a first negative acknowledgement in the one or more negative acknowledgements may further be based on the distance being larger than a threshold. In some embodiments, a criterion in the one or more criteria may be based on a received signal received power (RSRP) measured at the first user equipment (UE). In some embodiments, transmitting a first negative acknowledgement in the one or more negative acknowledgements may further be based on the received signal received power (RSRP) being smaller than a threshold.

In some embodiments, the sidelink control information (SCI) may comprise a field with a value indicating whether negative acknowledgement only feedback is enabled or disabled.

In some embodiments, the sidelink control information (SCI) may comprise a field with a value indicating one of a plurality of feedback modes.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

Clause 1. A method of enhanced retransmission in sidelink communications comprising the steps of:
determining, by a user equipment (UE) based on a first number of blind retransmissions in a blind retransmission mode, a plurality of resources for an initial transmission and a blind retransmission of a first transport block (TB) via a physical sidelink shared channel (PSSCH);
transmitting the first TB and the first number of blind retransmissions of the first TB; and
in response to not receiving a positive acknowledgement after the first number of the blind retransmissions, switching from the blind retransmission mode to a hybrid automatic repeat request (HARQ)-based retransmission mode.

Clause 2. The method of clause 1, wherein the first number indicates a maximum number of blind retransmissions.

Clause 3. The method of clause 1, further comprising receiving one or more messages comprising a first configuration parameter indicating the first number.

Clause 4. The method of clause 3, wherein the one or more messages comprise one or more radio resource control (RRC) messages.

Clause 5. The method of clause 1, further comprising receiving a downlink control information (DCI) indicating the first number.

Clause 6. The method of clause 5, wherein the downlink control information (DCI) comprises scheduling information for scheduling of the first transport block (TB).

Clause 7. The method of clause 6, wherein:
the downlink control information (DCI) indicates first radio resources; and
determining the plurality of resources is further based on the first radio resources.

Clause 8. The method of clause 7, wherein:
the resources of the plurality of resources are arranged in consecutive slots; and
frequency-domain resources of the plurality of resources are based on the first radio resources.

Clause 9. The method of clause 1, further comprising receiving a downlink control information (DCI) comprising scheduling information for scheduling the first transport block (TB) and an indication of first radio resources, wherein determining the plurality of resources is further based on the first radio resources and the first number.

Clause 10. The method of clause 9, wherein:
the resources of the plurality of resources are in consecutive slots; and
frequency-domain resources of the plurality of resources are based on the first radio resources.

Clause 11. The method of clause 1, further comprising:
receiving a positive acknowledgement; and
transmitting the first transport block (TB) in the hybrid automatic repeat request (HARQ)-based retransmission mode.

Clause 12. A method of enhanced retransmission in sidelink communications, comprising the steps of:
receiving, by a first user equipment (UE) from a second UE, an initial transmission and one or more blind retransmission of a first transport block (TB) via a physical sidelink shared channel (PSSCH);
determining, by the first UE and based on the initial transmission and the one or more blind retransmissions of the first TB, that the first TB is received correctly; and
transmitting, by the first UE, an indication to release first radio resources of a plurality of resources used for the blind retransmission of the first TB that occur after correct reception of the first TB.

Clause 13. The method of clause 12, wherein transmitting the indication is via a scheduling request.

Clause 14. The method of clause 13, wherein the indication is transmitted by the first UE to a base station (BS).

Clause 15. The method of clause 13, wherein transmitting the scheduling request is via a physical uplink control channel (PUCCH).

Clause 16. The method of clause 12, wherein the indication is a hybrid automatic repeat request (HARQ) feedback.

Clause 17. The method of clause 12, wherein the indication is transmitted via one or more radio resource control (RRC) messages.

Clause 18. The method of clause 12, wherein the indication is transmitted via a physical uplink control channel (PUCCH).

Clause 19. The method of clause 12, wherein the indication is transmitted via a physical uplink shared channel (PUSCH).

Clause 20. A method of enhanced retransmission in sidelink communications, comprising the steps of:
receiving, by a first user equipment (UE) from a second UE, sidelink control information (SCI) comprising scheduling information for a first transport block (TB), wherein the first UE is in a groupcast set;
receiving, by the first UE from the second UE, the first TB; and
transmitting, by the first UE, a first negative acknowledgement where the first TB is received incorrectly by the first UE.

Clause 21. The method of clause 20, wherein the receiving includes receiving one or more repetitions of the first transport block (TB), and the transmitting includes transmitting second or more negative acknowledgments, where the first TB is received incorrectly until the first TB is received correctly through the one or more repetitions, and wherein the one or more repetitions of the first TB are based on blind retransmissions by the second user equipment (UE).

Clause 22. The method of clause 20, wherein the first user equipment (UE) does not transmit a negative acknowledgement when the first transport block (TB) is received correctly.

Clause 23. The method of clause 20, wherein receiving the sidelink control information (SCI) is via a physical sidelink control channel (PSCCH).

Clause 24. The method of clause 21, wherein receiving the one or more repetitions of the first TB is via a physical sidelink shared channel (PSSCH).

Clause 25. The method of clause 21, wherein transmitting the second or more negative acknowledgements is via a physical sidelink feedback channel (PSFCH).

Clause 26. The method of clause 21, wherein:
the groupcast set comprises a plurality of user equipments (UEs) comprising the first UE; and
the first transport block (TB) is received by the plurality of UEs.

Clause 27. The method of clause 26, wherein the plurality of user equipments (UEs), in the groupcast set, share physical sidelink feedback channel (PSFCH) resources for transmission of the second or more negative acknowledgements.

Clause 28. The method of clause 20, wherein transmitting the first negative acknowledgement is further based on one or more criteria.

Clause 29. The method of clause 28, wherein a criterion in the one or more criteria is based on a parameter.

Clause 30. The method of clause 29, further comprising receiving one or more messages comprising the parameter.

Clause 31. The method of clause 30, wherein the one or more messages comprise a radio resource control (RRC) message.

Clause 32. The method of clause 28, wherein a criterion in the one or more criteria is based on a zone that the first user equipment (UE) is located in.

Clause 33. The method of clause 32, wherein the first user equipment (UE) is associated with a first zone identifier and the second UE is associated with a second zone identifier.

Clause 34. The method of clause 33, wherein the sidelink control information (SCI) comprises parameters indicating at least one of the first zone identifier and the second zone identifier.

Clause 35. The method of clause 28, wherein a criterion in the one or more criteria is based on a distance between the first user equipment (UE) and the second UE.

Clause 36. The method of clause 35, wherein transmitting the first negative acknowledgement is further based on the distance being larger than a threshold.

Clause 37. The method of clause 28, wherein a criterion of the one or more criteria is based on a received signal received power (RSRP) measured at the first user equipment (UE).

Clause 38. The method of clause 37, wherein transmitting the first negative acknowledgement is further based on the received signal received power (RSRP) being smaller than a threshold.

Clause 39. The method of clause 20, wherein the sidelink control information (SCI) comprises a field with a value indicating whether negative acknowledgement only feedback is enabled or disabled.

Clause 40. The method of clause 20, wherein the sidelink control information (SCI) comprises a field with a value indicating one of a plurality of feedback modes.

1. A method of enhanced retransmission in sidelink communications comprising the steps of:
determining, by a user equipment (UE) based on a first number of blind retransmissions in a blind retransmission mode, a plurality of resources for an initial transmission and a blind retransmission of a first transport block (TB) via a physical sidelink shared channel (PSSCH);
transmitting the first TB and the first number of blind retransmissions of the first TB; and
in response to not receiving a positive acknowledgement after the first number of the blind retransmissions, switching from the blind retransmission mode to a hybrid automatic repeat request (HARQ)-based retransmission mode.

2. The method of claim 1, wherein the first number indicates a maximum number of blind retransmissions.

3. The method of claim 1, further comprising receiving one or more messages comprising a first configuration parameter indicating the first number.

4. The method of claim 3, wherein the one or more messages comprise one or more radio resource control (RRC) messages.

5. The method of claim 1, further comprising receiving a downlink control information (DCI) indicating the first number.

6-10. (canceled)

11. The method of claim 1, further comprising:
receiving a positive acknowledgement; and
transmitting the first transport block (TB) in the hybrid automatic repeat request (HARQ)-based retransmission mode.

12. A method of enhanced retransmission in sidelink communications, comprising the steps of:
receiving, by a first user equipment (UE) from a second UE, an initial transmission and one or more blind retransmission of a first transport block (TB) via a physical sidelink shared channel (PSSCH);
determining, by the first UE and based on the initial transmission and the one or more blind retransmissions of the first TB, that the first TB is received correctly; and
transmitting, by the first UE, an indication to release first radio resources of a plurality of resources used for the blind retransmission of the first TB that occur after correct reception of the first TB.

13. The method of claim 12, wherein transmitting the indication is via a scheduling request.

14-15. (canceled)

16. The method of claim 12, wherein the indication is a hybrid automatic repeat request (HARQ) feedback.

17. The method of claim 12, wherein the indication is transmitted via one or more radio resource control (RRC) messages.

18. The method of claim 12, wherein the indication is transmitted via a physical uplink control channel (PUCCH).

19. The method of claim 12, wherein the indication is transmitted via a physical uplink shared channel (PUSCH).

20. A method of enhanced retransmission in sidelink communications, comprising the steps of:
receiving, by a first user equipment (UE) from a second UE, sidelink control information (SCI) comprising scheduling information for a first transport block (TB), wherein the first UE is in a groupcast set;
receiving, by the first UE from the second UE, the first TB; and
transmitting, by the first UE, a first negative acknowledgement where the first TB is received incorrectly by the first UE.

21. The method of claim 20, wherein the receiving includes receiving one or more repetitions of the first transport block (TB), and the transmitting includes transmitting second or more negative acknowledgments, where the first TB is received incorrectly until the first TB is received correctly through the one or more repetitions, and wherein the one or more repetitions of the first TB are based on blind retransmissions by the second user equipment (UE).

22-25. (canceled)

26. The method of claim 21, wherein:
the groupcast set comprises a plurality of user equipments (UEs) comprising the first UE; and
the first transport block (TB) is received by the plurality of UEs.

27. The method of claim 26, wherein the plurality of user equipments (UEs), in the groupcast set, share physical sidelink feedback channel (PSFCH) resources for transmission of the second or more negative acknowledgements.

28. The method of claim 20, wherein transmitting the first negative acknowledgement is further based on one or more criteria.

29. The method of claim 28, wherein a criterion in the one or more criteria is based on a parameter.

30-38. (canceled)

39. The method of claim 20, wherein the sidelink control information (SCI) comprises a field with a value indicating whether negative acknowledgement only feedback is enabled or disabled.

40. The method of claim 20, wherein the sidelink control information (SCI) comprises a field with a value indicating one of a plurality of feedback modes.
